(19) United States
(12) Patent Application Publication
(10) Pub. No.: US 2008/0080711 A1
(43) Pub. Date: Apr. 3, 2008

(54) Dual conditional access module architecture and method and apparatus for controlling same

(75) Inventors: Gregory J. Gagnon, Redondo Beach, CA (US); Ronald P. Cocchi, Seal Beach, CA (US); Dennis R. Flaharty, Irvine, CA (US)

Correspondence Address: GATES & COOPER LLP;HOWARD HUGHES CENTER, 6701 CENTER DRIVE WEST, SUITE 1050, LOS ANGELES, CA, 90045, US

(73) Assignee: SypherMedia International, Inc.

(21) Appl. No.: 11/529,409

(22) Filed: Sep. 28, 2006

(51) Int. Cl. H04N 7/167

(52) U.S. Cl. 380/239

(57) ABSTRACT

A method apparatus for providing conditional access to media programs is disclosed. The apparatus comprises a first conditional access module that is integral with a receiver; a second conditional access module that is removably communicatively coupleable with the receiver; and a conditional access kernel that controls the conditional access operations of the first conditional access module and the second conditional access module according to a control structure received by the receiver from a remote source.

### CROSS-REFERENCE TO RELATED APPLICATIONS

This application is related to the following U.S. patent applications, each of which applications are hereby incorporated by reference:

U.S. patent application Ser. No. 11/441,888, entitled “METHOD AND APPARATUS FOR SUPPORTING BROADCAST EFFICIENCY AND SECURITY ENHANCEMENTS,” by Ronald P. Cocchi and Frances C. McKee-Clabaugh, filed May 26, 2006;

U.S. Patent Application US2005/037197, entitled “METHOD AND APPARATUS FOR SUPPORTING MULTIPLE BROADCASTERS INDEPENDENTLY USING A SINGLE CONDITIONAL ACCESS SYSTEM,” by Ronald P. Cocchi, Gregory J. Gagnon, and Dennis R. Flaharty, and filed Oct. 18, 2005, which claims benefit of U.S. Provisional Patent Application No. 60/619,663, entitled “METHOD OF SUPPORTING MULTIPLE BROADCASTERS INDEPENDENTLY USING A SINGLE CONDITIONAL ACCESS SYSTEM,” by Ronald P. Cocchi, Gregory J. Gagnon, and Dennis R. Flaharty, filed Oct. 18, 2004; and

U.S. patent application Ser. No. 11/483,909, entitled “CONDITIONAL ACCESS ENHANCEMENTS USING AN ALWAYS-ON SATELLITE BACKCHANNEL LINK,” by Gregory J. Gagnon, Ronald P. Cocchi, and Dennis R. Flaharty, filed Jul. 10, 2006.

### BACKGROUND OF THE INVENTION

1. Field of the Invention

The present invention relates to systems and methods for providing conditional access to media programs, and in particular to a system and method for enhancing the software kernel functionality in the Set Top Box (STB) for providing for such conditional access entitlement and control messages in a Digital Video Broadcasting (DVB) System.

2. Description of the Related Art

For many years, media programs such as television and radio programs have been broadcast to viewers/listeners free of charge. More recently, this free-of-charge dissemination model has been augmented with a fee-for-service and/or fee-for-view model in which paying subscribers are provided access to a greater variety and number of media programs, including video programs, audio programs and the like, by cable, satellite and terrestrial broadcasts.

However, while subscriber-based services are readily available in some areas, they are not available on a world-wide basis. Further, in current media program subscription business models, subscribers are typically offered services from a small number of providers (e.g. DIRECTV or ECHOSTAR, or the approved local cable provider) each of which typically provide a large number of media channels from a variety of sources (e.g. ESPN, HBO, COURT TV, HISTORY CHANNEL). To assure that only subscribers receive the media programs, each service provider typically encrypts the program material and provides equipment necessary for the customer to decrypt them so that they can be viewed.

One of the roadblocks to the evolution of such services is the means by which the service provider assures that only paying customers receive their media programs. Existing conditional access systems were initially developed for small markets and grew to larger markets over a long period of time. This growth has attributed to the success of the pay TV industry but has come at some cost to the conditional access infrastructure. The design initially conceived in the smaller system did not scale well as the once small system with relatively few subscribers became large with millions of subscribers. This resulted in the deployment of STB Kernels that were unable to support diverse security and business features necessary to provide sufficient security. Such features include those related to improved control over conditional access module functionality such as (1) controlling which conditional access modules operate with which receivers (2) remotely controlling the operability of deployed conditional access modules, (3) enabling the migration from deployed conditional access modules to improved, later generation conditional access modules while minimizing service disruption and loss of data use of transmission bandwidth otherwise used for media programs and (4) remotely controllable authorization/deauthorization of services to customers depending on their geographical location or service authorizations.

What is needed is a simple, efficient means to provide the foregoing functionality. The present invention satisfies these needs.

### SUMMARY OF THE INVENTION

To address the requirements described above, the present invention discloses a method, apparatus, article of manufacture for providing conditional access to media programs. In one embodiment, this invention is evidenced by a receiver, having an integral first conditional access module; a second conditional access module, removably communicatively coupleable with the receiver; and a conditional access kernel, for controlling conditional access operations of the first conditional access module and the second conditional access module according to a control structure received by the receiver from a remote source. In another embodiment, the invention is evidenced by a method for providing conditional access to media programs. The method comprises the steps of receiving a control structure from a remote source in a conditional access kernel of a receiver that receives the media programs; and controlling the operations of the first conditional access module and the second conditional access module according to the control structure, wherein the first conditional access module is integral with the receiver and the second conditional access module removably coupleable with the receiver.

The foregoing allows conditional access providers to support a diverse set of security and business features in their STBs. These features include (1) controlling which conditional access modules operate with which receivers (2) remotely controlling the operability of deployed conditional access modules, (3) enabling the migration from deployed conditional access modules to improved, later generation conditional access modules while minimizing service disruption and loss of data use of transmission bandwidth otherwise used for media programs and (4) remotely controllable authorization/deauthorization of services to customers depending on their geographical location or service authorizations.

In one embodiment, the components of this architecture include a headend, which exists at each broadcaster location, a conditional access kernel, an integral conditional access module which resides in STBs that receive the broadcasted signal, and a second conditional access module that is removably coupleable with the STB. The headend residing at each broadcaster location includes a web transaction server, conditional access subscriber administration system and broadcast and security processing server.

The subscriber administration system and broadcast and security processing server send messages related to the integral control access module via the conditional access kernel that resides in the customer's STB. The conditional access kernel processes these messages, allocates operations between the integral and removable conditional access modules, and forwards the appropriate messages between the conditional access modules. The conditional access kernel also provides for communications between the removable conditional access module and the integral conditional access module, permitting data to be transferred to a new removable conditional access module when required.

### BRIEF DESCRIPTION OF THE DRAWINGS

Referring now to the drawings in which like reference numbers represent corresponding parts throughout:

FIG. 1 is a diagram illustrating a media program distribution system;

FIGS. 2A and 2B are diagrams of a representative data stream and the packets produced by the media program distribution system;

FIG. 2C is a diagram of a typical subscriber station;

FIG. 3 is a diagram illustrating how a conditional access module decrypts an encrypted control word;

FIG. 4 is a diagram of a conditional access system architecture; and

FIG. 5 is a flow chart illustrating exemplary method steps that can be used to practice one embodiment of the present invention.

### DETAILED DESCRIPTION OF PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

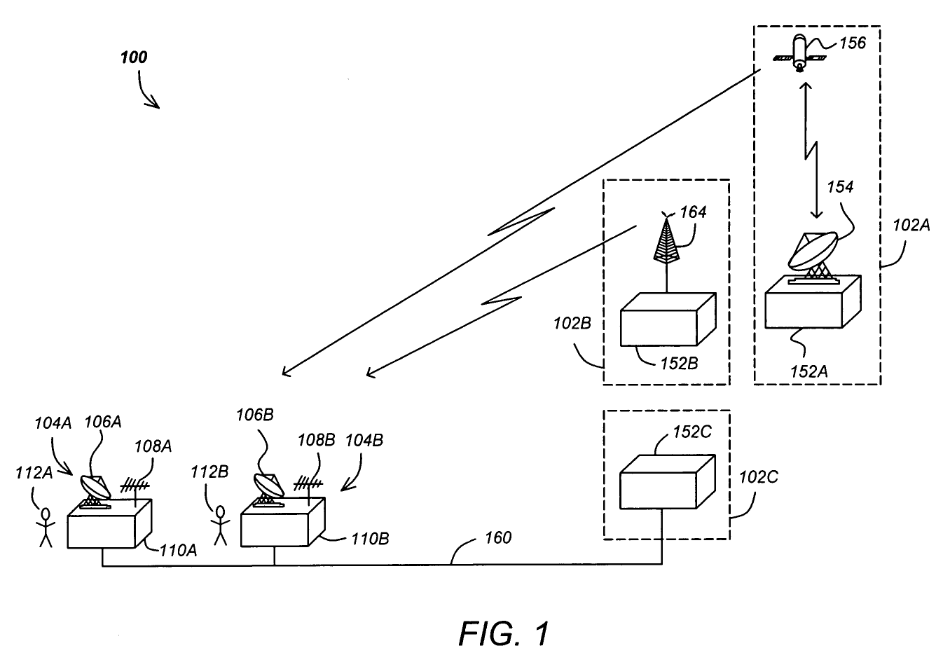

FIG. 1 is a diagram illustrating a media program distribution system 100. The system 100 includes a plurality of service providers (hereinafter alternatively referred to as broadcasters) 102, including a first service provider 102A that broadcasts media programs from a satellite broadcast facility 152A via one or more uplink antennas 154 and one or more satellites 156, a second service provider 102B, that broadcasts media programs from terrestrial broadcast facility 152B and one or more terrestrial antennas 164, and a third service provider 102C that broadcasts media programs from cable broadcast facility 152C via a cable link 160.

The system 100 also comprises a plurality of subscriber stations 104A, 104B (alternatively referred to hereinafter as subscriber station(s) or receiving station(s) 104), each providing service to one or more subscribers 112A and 112B (alternatively referred to hereinafter as subscribers 112). Each subscriber station 104A, 104B may include a satellite reception antenna 106A, 106B (alternatively referred to hereinafter as satellite reception antenna 106) and/or a terrestrial broadcast antenna 108A, 108B (alternatively referred to hereinafter as terrestrial broadcast antenna 108) communicatively coupled to a receiver 110A, 110B (alternatively referred to hereinafter as receiver(s) 110, set top box(es) (STBs), or integrated receiver/decoder(s) (IRDs)).

### Broadcast Data Stream Format and Protocol

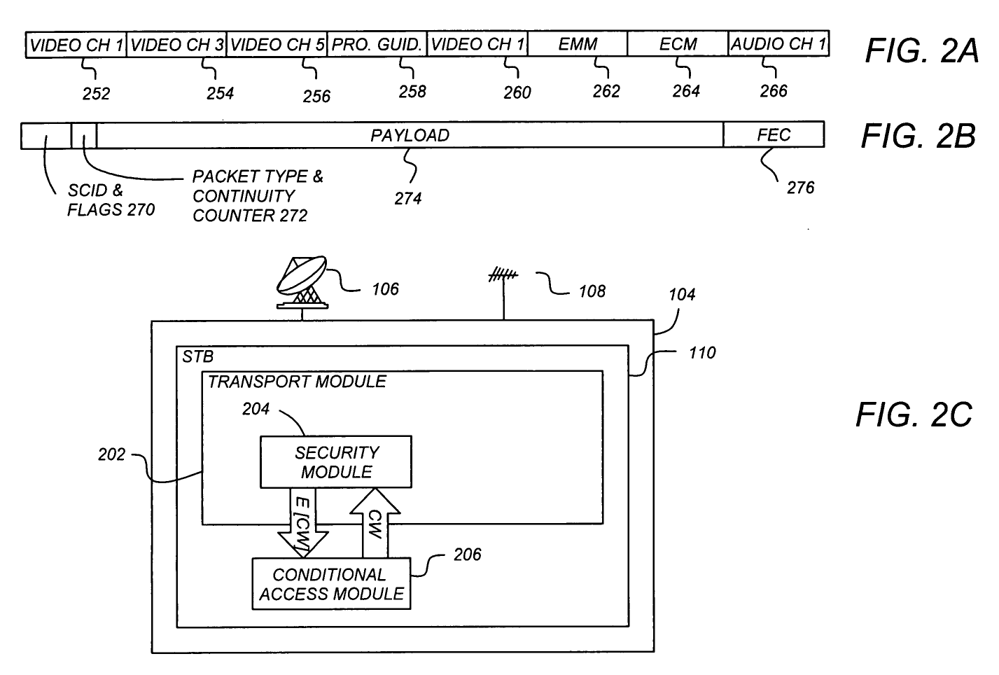

FIG. 2A is a diagram of a representative data stream. The data stream comprises a plurality of packets combined by time division multiple access (TDMA) techniques, with each packet identified by a system channel identifier or SCID.

The first packet segment 252 comprises information from a first video channel (for a first media program). Packet segment 254 comprises information relevant for video channel 3 254 (a second media program). Packet segment 256 comprises information from video channel 5 (for yet another media program). Packet segment 258 comprises program guide information such as the information provided by the program guide subsystem. Packet 260 comprises additional first media channel information. Packet 262 includes an entitlement management message (EMM) 262, which carries entitlement management information that is used by the receiving station 104 to determine whether the user is permitted to view or record media programs on one or more of the media channels, as described further below. Packet 266 includes the audio information for the media program transmitted on video channel 1. The data stream includes a packet with an entitlement control message (ECM) 264. The ECM is also used to determine whether the user is permitted to view or record the media programs on the media channels, as described below.

The data stream therefore comprises a series of TDMA packets from a number of data sources. The data stream is modulated and transmitted on a frequency band to the satellite via the antenna 154. The receiving station 104 receives these signals via the antenna 106, and using the system channel identifier (SCID) described below, reassembles the packets to regenerate the program material for each of the channels.

FIG. 2B is a diagram of a representative data packet. Each data packet (e.g. 252-266) comprises a number of packet segments. The first packet segment 270 comprises two bytes of information containing the SCID and flags. The SCID is a unique 12-bit number that uniquely identifies the data packet's data channel. The data channel includes the information that is required to reproduce the media program at the receiver station. For example, since the video for channel 1 is in packets 252 and 260 of the data stream, and the audio for channel 1 is in packet 266, each of these packets will have the same SCID. Also, although the EMM transmits entitlement information related to more than one media program, the ECM typically includes information relating to only one media program and is transmitted with the same stream as the media program as well.

The flags include 4 bits that are used to control other features. The second packet segment 272 is made up of a 4-bit packet type indicator. The packet type identifies the packet by data type (video, audio, ECM, etc.). When combined with the SCID, the packet type determines how the data packet will be used. The next packet segment 274 comprises 127 bytes of payload data, which in the cases of packets 252 is a portion of the video program provided by the video program source. The final packet segment 276 is data required to perform forward error correction.

FIG. 2C is a diagram of a typical subscriber station 104. Each station 104 includes at least one receiver or STB 110, which itself includes a transport module 202 that communicates with one or more conditional access modules (CAMs) 206. One embodiment of the present invention utilizes two or more CAMs 206, including one CAM 206 having one or more electrical devices that are integral with the STB 110, and a second CAM 206 that is embodied in a smartcard or other device that is removably coupleable to the STB 110. An exemplary STB 110 is disclosed in U.S. Pat. No. 6,701,528, which is hereby incorporated by reference herein.

To assure that only those who subscribe to the service are provided with media programs, the service providers typically encrypt the media program M with a control word CW, thus producing an encrypted program E_{CW}[M], and transmit the encrypted media program E_{CW}[M] and an encrypted version of the control word E_{K}[CWᵢ] to the STB 110. The STB 110 receives both the encrypted program E_{CW}[M] and the encrypted control word E_{K}[CWᵢ]. The transport module 202 analyzes the incoming data stream and passes the encrypted control word E_{K}[CWᵢ] to the CAM(s) 206, which decrypt the control word CWᵢ and returns the decrypted control word CWᵢ to a security module 204 or similar device in the transport module 202. The security module 204 then uses the control word CWᵢ to decrypt the encrypted media program E_{CW}[M] to produce the media program M for presentation to the subscriber. This system assures that only those who are in possession of a valid CAM(s) 206 and are authorized to decrypt the control word can receive and decode media programs. However, it does not prevent the use of a removably coupleable (hereinafter “removable”) CAM 206 in any other STB 110. Hence, if the CAM 206 is compromised or duplicated, unauthorized access to media programs is possible.

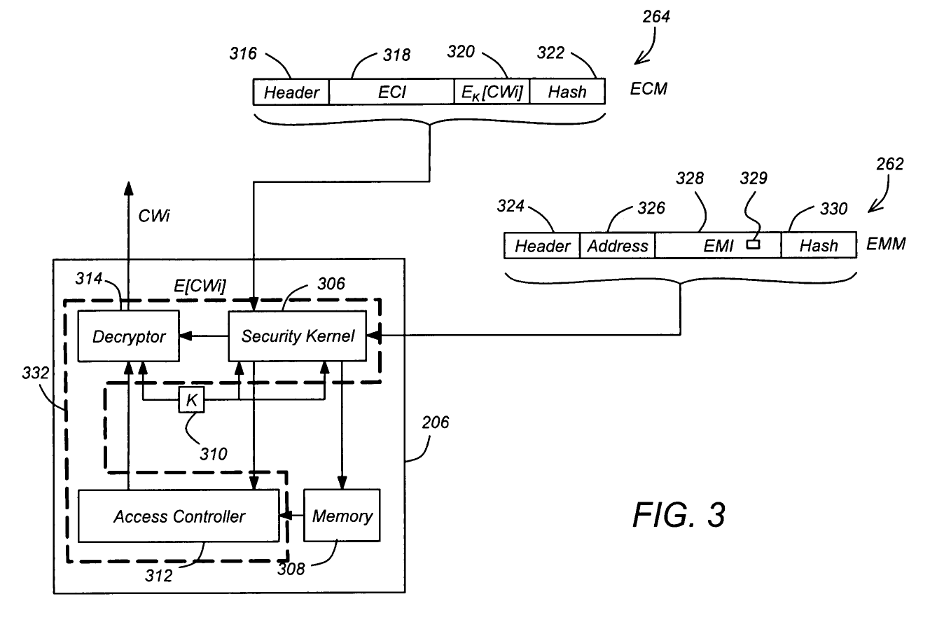

FIG. 3 is a diagram illustrating further details regarding how the CAM 206 decrypts the encrypted control word E_{K}[CWᵢ]. Entitlement control information (ECI) 318 and entitlement management information (EMI) 328 are provided to the CAM 206 in an entitlement control message (ECM) 264 and an entitlement management message (EMM) 262, respectively. Typically, the ECM 264 and the EMM 262 are transmitted to the STB 110 by the broadcaster or media program provider 102 in the same data stream as the media program, but in separate packets. Either or both of the ECM 264 and EMM 262 may also be sent in a data stream and a communication path distinct from the data stream and path used to transmit the media program.

The ECM 264 typically comprises a header 316, ECI 318, an encrypted control word E_{K}[CWᵢ] 320 and a hash value 322. The EMM 262 typically comprises a header 324, an address 326, EMI 328 that defines what services or programs the subscriber is permitted access to, and a hash value 330. In one embodiment, the EMI 328 also includes a control information hereinafter referred to as a control structure 329 that is used to control he operations a conditional access kernel, and hence, the CAM(s) 206. The use of the control structure 329 is further described below.

In one embodiment, the ECM 264 and EMM 262 are provided to a security kernel 306 for authentication before further use. Authentication can be accomplished in a number of ways. For example, the ECM 264 may include a hash 322 of the access conditions 318, generated using the same key (K) that is used to encrypt the control word (CW). In this case, the security kernel 306 uses the locally stored key (K) 310 to compute a hash of the access conditions 318, and compares the result with the hash 322 value in the ECM 264. If the computed and recited hash compare favorably, the access conditions 318 are verified, and the ECM 264 is authenticated for use. The same technique can be used to verify the encrypted control word E_{K}[CWᵢ] 320 and the access information 328 as well (e.g. by comparison of the hash 330 received in the EMM 262 and a hash computed using the key 310).

Although FIG. 3 illustrates a single security kernel 306, the ECM 264 and the EMM 262 can be verified by different security kernels, and using different keys if desired. Also, the access controller 312, security kernel 306 and decryptor 314 may be implemented by a single processor 332 or different, perhaps special purpose processors. Once verified, the access information 328 from the EMM 262 is stored in storage 308 and made available to the access controller 312.

In another embodiment, the control word CWᵢ and the access control information 318 can be encrypted according to the key (K) (resulting in E_{K}[CWᵢ+ACI] or E_{K}[CWᵢ] and E_{K}[ACI]). In this case, the access control information ACI is decrypted by the decryptor 314, sent to the access controller 312 where it is compared to the entitlement management information stored in memory 308. If the comparison indicates that the media program should be made available to the subscriber, the access controller instructs the decryptor 314 to decrypt the encrypted control word E_{K}[CWᵢ] to produce the control word CWᵢ, and the control word CWᵢ is used to decrypt the media program.

The access controller 312 compares the access condition information 318 with the access entitlement information 328 to determine if the subscriber should have access to the media program that was encrypted with the control word CWᵢ. If so, the access controller 312 instructs the decryptor 314 to decrypt the encrypted control word E_{K}[CWᵢ] using key 310 to produce the control word CWᵢ. The STB 110 uses the control word to decrypt the media program.

As described above, EMMs 262 can be used to extend the service authorization period for paid programming services stored on a subscriber's conditional access module 206. This can be accomplished by pushing the expiration date forward in time or generating new EMMs 262 for each service and sending them to the conditional access module 206. These EMMs 262 can be delivered to the conditional access module 206 using positive addressing. This permits the message to be addressed to a single smart card (unique addressing) or to a group of cards (group addressing).

Group addressing can be used to send an updated or new EMM 262 to the CAMs 206 of subscribers who have subscribed to a particular service. However, group addressing is typically less effective since the group size is usually too small compared to the large number of subscribers that are subscribed to many services. Addressing groups also becomes less effective over time because group membership dwindles as subscribers 112 end their service or CAMs 206 fail.

Unique addressing (sending renewal EMMs 262 by individual service separately to each CAM 206) is also extremely inefficient. For example, if a broadcaster had 20 million smart cards in the field and each card had 30 services, the broadcaster may be required to send 600 million EMMs 262 to renew the services for all CAMs 206 and services on the CAMs 206. This is extremely expensive in terms of bandwidth that could be used for other purposes including offering additional pay services.

With large subscriber populations, a significantly more efficient method of distributing service data and renewals is desired, particularly when using positive addressing to distribute information to a group of subscribers 112. As described in the related patent application, “METHOD AND APPARATUS FOR SUPPORTING BROADCAST EFFICIENCY AND SECURITY ENHANCEMENTS,” by Ronald P. Cocchi and Frances C. McKee-Clabaugh described above, this can be accomplished by transmitting a service bitmap for the services stored on a CAM 206.

### System Architecture

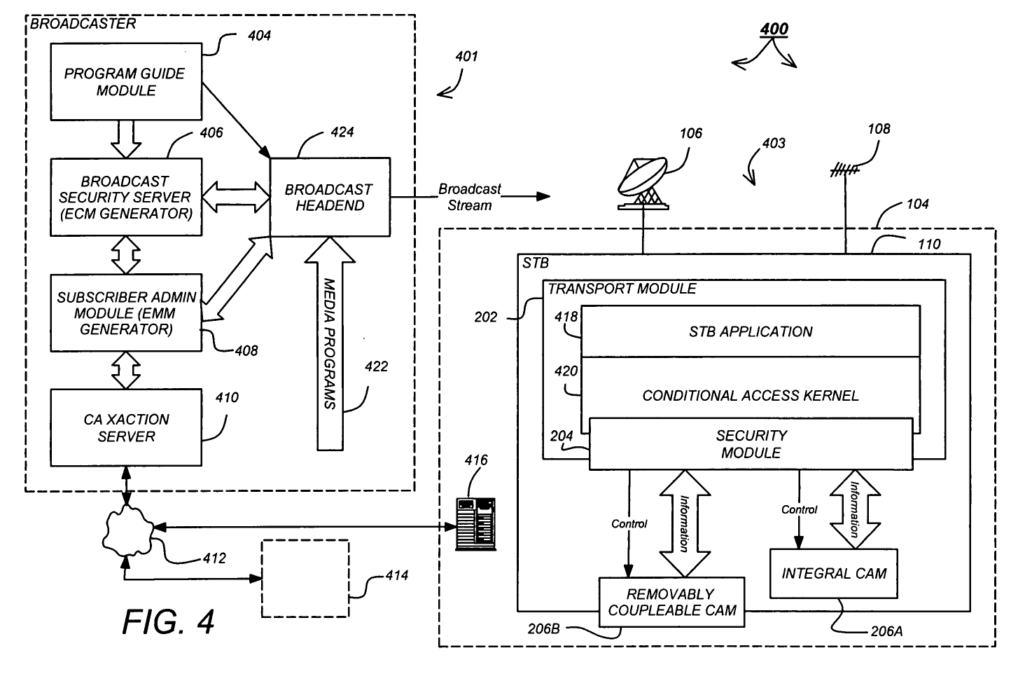

FIG. 4 is a diagram of a conditional access system 400 that can be used to transmit the EMM 262 and the ECM 264 to the receiving stations 104. The conditional access system 400 includes a broadcaster segment 401 and a receiver segment 403.

The broadcasters segment 401 includes a broadcast headend 424 that is communicatively coupled to a program guide module 404, a broadcast security server 406, and a subscriber administration module 408 to control subscriber 112 access to the media programs 422.

The subscriber administration module (SAM) 408 generates the EMMs 264 and ECMs 262 as described above, and provides them to the broadcast headend 424 for assembly into the broadcast data stream transmitted to the receiver station 104. The SAM 408 also controls the rate and time at which EMMs 262 are inserted into the broadcast stream. The SAM 408 also adds, deletes, and modifies authorized programming for the subscriber 112, controls the subscriptions, and handles service renewal requests. Subscriptions include pay-per-view events such as order ahead pay-per-view (OPPV) and impulse pay-per-view (IPPV) events. Unlike OPPV events, IPPV events do not require transmission of individual authorization messages.

The broadcast security server (BSS) 406 generates the ECM 264, and performs the hashing, combining, and/or encrypting operations required to generate both the transmitted EMM 262 and ECM 264. The BSS 406 also inserts the ECM 264 in the broadcast stream and controls the rate of ECM 264 insertion into the broadcast stream. ECMs 264 and EMMs 262 include the activation, authorization, and general commands targeted for all CAMs 206, groups of CAMs 206, a subscriber's specific CAM 206, or one or more replacement CAMs 206.

The broadcaster segment 401 transmits EMM 262 and ECM 264 messages to the receiver segment 403 to the STB application 418 and conditional access kernel 420, where processing is performed to determine which services should be provided to the subscriber. Such processing is performed by a processor in the STB 110 using instructions stored in a memory of the STB 110.

The receiver segment 403 includes a receiver station 104 having an STB 110. The STB 110 includes a transport module 202, which handles the flow of the received broadcast data stream within the STB 110, and directs messages according to the SCID associated with the message. The transport module 202 also includes an STB application 418 interfacing with a first CAM 206A and a second CAM 206B via a conditional access kernel 420 and a security module 204. In the illustrated embodiment, the first CAM 206A is integral with the STB 100, and may even be integral with the transport module 202, and the second CAM 206B is removably coupleable with the STB 110. In one embodiment, the second CAM 206B comprises a smart card having a security chip.

As described above with respect to FIG. 3, the CAMs 206 process the EMM 262 and ECM 264 to limit media program access to subscribers. While the conditional access kernel 420 and STB application 418 are illustrated as being part of the transport module 202, they may be incorporated into the conditional access module 206 or any part of the STB 110.

Users subscribe to the media service by providing STB-identifying information to the conditional access system 400. This can be accomplished via a computer 416 at the receiver station. In one embodiment, the user uses an Internet browser executing on the computer 416 to enter STB 110 identifying information. The information is transmitted to the broadcaster 102 via the Internet 412. This can also be accomplished by calling a broadcaster customer service representative, or by any other means known in the art. Web-based authorization is the preferred method of accepting service requests because it requires little or no human intervention between the transaction server 410 and the subscriber 112.

The subscriber 112 can subscribe to a wide variety of services, including ordinary subscription services, pay-per-view (PPV) media programs, select any order ahead pay-per-view (OPPV) media programs, and impulse pay-per-view (IPPV) media programs. Billing for those services can be accomplished via a third party 414 such as PAYPAL or a credit card agency. The subscriber 112 can also pre-authorize a credit that can be sent to the conditional access module 206. The subscriber 112 can repeat this process for each media program or group of media programs that they would like to receive.

The conditional access transaction server 410 accepts this information and initiates activation of the service by providing the information to the subscriber administration module 408. An activation component controls the activation of the conditional access module 206/STB 110 pairs, and keeps track of such pairings to assure integrity.

### Virtual Group Distribution of EMMs to Fielded CAMs

In one embodiment, the present invention also allows efficient distribution of EMMs 262 to deployed CAMs 206 (already provided to subscribers 112 and installed into STBs 110). This is accomplished by defining “virtual groups” of CAMs 206 that should receive the EMMs 262. Data defining virtual groups can be pre-loaded into the CAMs 206 provided to new subscribers 112, or can be loaded into the CAM 206 by a data packet in a manner similar to that which is used to transmit EMMs 262 to the CAM 206. Once the group data is stored in the CAM 206, it can be sent to the conditional access kernel 420. Upon power up (or insertion of the CAM 206 into the STB 110), the group identifier and the CAM 206 identifier are passed from the CAM 206 to the conditional access kernel 420 and the conditional access kernel 420 uses that information to determine whether an EMM 262 transmitted in the program stream should be provided to the CAM 206. The EMM's header 324 can be used to identify the EMM 262 so that the conditional access kernel 420 can identify the EMM 262 as a “group” EMM 262 that should be provided to the CAM 206. Virtual groups can therefore be used to efficiently distribute group EMMs, thus saving bandwidth within the broadcast infrastructure because individually addressed EMMs are not required. Broadcasting to legacy groups become less effective as the card population ages and legacy groups become more sparse. Legacy groups become sparse because subscribers churn out and cards fail or become damaged. Since the broadcaster 102 has knowledge of which CAMs 206 belong to which groups, the broadcaster 102 can optimally define the virtual groups to minimize transmission and memory requirements.

### Conditional Access Kernel and CAM Operations

The subscriber's receiver or STB 110 provides conditional access is provided to media programs by cooperative interaction of the CAK 420 and one or both of the integral CAM 206A and the removable CAM 206B. As described above, both CAMs 206 provide conditional access to media programs by processing EMMs 262 and ECMs 264 in order to locally generate entitlement control information 318 and control words CW. The CAK 420 controls the operations of the integral CAM 206A and the removable CAM 206B according to a control structure 329 received from a remote source such as the headend 424. Such controlled operations may include (1) management of communication with both the integral CAM 206A and the removable CAM 206B, (2) processing of a conditional access table (CAT), (3) processing of ECMs 262 and EMMs 264, (4), supporting IPPV-related operations, (6) providing on-screen display (OSD) messages to the user, and (7) supporting the substitution of newer removable CAMs 206B without loss of data.

In one embodiment, the CAK 420 also allocates conditional access operations between the integral CAM 206A and the removable CAM 206 (and in embodiments with three or more CAM(s) 206, the additional CAM(s) 206 as well), using information provided in the control structure 329. This operational allocation is therefore remotely controllable, and may include several different embodiments.

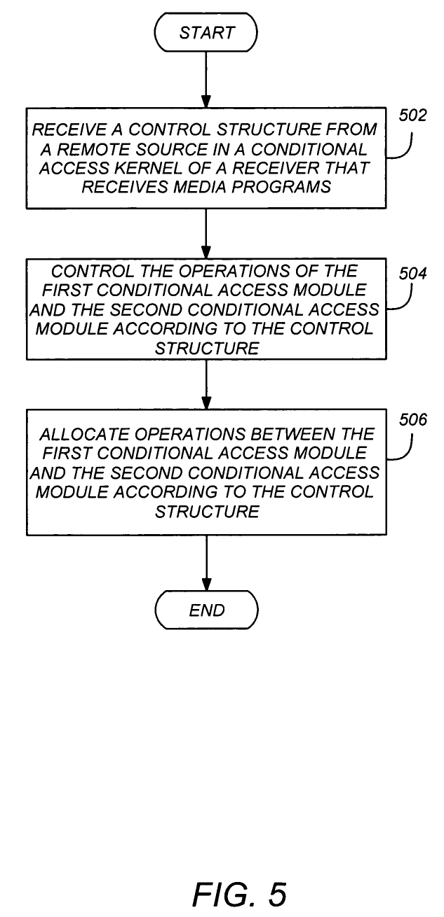

FIG. 5 is a flow chart illustrating exemplary method steps that can be used to practice one embodiment of the present invention. In block 502, a control structure 329 is received from a remote source such as a headend 424 or a conditional access system provider independent from the headend 424 in an STB 110 that receives media programs. As is further described below, the control structure 329 may be received in an EMM 262 that is periodically transmitted to the STB 110. In block 504, the operations of the first conditional access module 206A and the second conditional access module 206B are controlled by the conditional access kernel 420 according to the received control structure 329. Optionally, in block 506, operations that are to be performed in providing conditional access are allocated between the first conditional access module 206A and the second conditional access module 206B, also according to the control structure 329.

In perhaps the simplest case, the operational allocation is as simple as selecting which CAM 206 of the two CAMs 206 will be operational and which will not. The operational allocation may depend on the operating mode of the STB 110 or receiver station 104. For example, the CAK 420 may allocate all initialization operations (operations that permit the STB 110 to receive at least unencrypted media programs when the STB 110 is initially installed in the subscriber's home) to the integral CAM 206A, and post-initialization operations (such as decrypting encrypted control words, hashing, verification, or the other operations shown in FIG. 3 to the removable CAM 206B) once it is inserted into the STB 110.

Operational allocations may also be made upon the security requirements of the operation itself. For example, operations requiring greater security may be allocated to the integral CAM 206A, with operations having less security allocated to the removable CAM 206B. Conversely, operations requiring greater security may be allocated to the removable CAM 206B so that newer CAMs 206 with improved security operations can be deployed.

Operational allocations may also be temporally adjusted in order to make the system less vulnerable to compromise by hackers. Operational allocations may also depend upon the operational status of each CAM 206, as determined by the CAM 206 itself, the STB 100, or other systems. For example, should the removable CAM 206B detect that it is being tampered with (or has been tampered with in the past), it may send a message to the CAK 420 indicating such tampering has taken place, upon which the CAK 420 may disable the removable CAM 206B, report the tampering to the headend 424 or other authority, or take other action as would be appropriate. This may include, for example, entering a minimum functionality mode using the integral CAM 206A alone, or allocating only the functionality that was tampered with to the integral CAM 206A.

Significantly, the allocation of operations is remotely controllable via the control structure 329 sent to the STB 110. This allows the operational allocation to be flexible, and either proactive or reactive to hacking techniques as they develop and are identified.

The CAK 420 is also responsible for managing communications with the integral CAM and further, responsible for managing communications with the removable CAM 206B. In one embodiment, communications with the integral CAM 206A are implemented through a hardware independent application program interface (API) that is implemented by the STB application 418. These communications include those related to initialization, CAM selection, communication error handling, protocol (minimum time and timeout, semaphores, and task/communication prioritization) and transfer data blocks, and are discussed further below. The same processes are true for the removable CAM 206B.

It is also possible to use the control structure 329 to program the operational allocation between the integral CAM 206A and the removable CAM 206B based on the occurrence of particular events. For example, it may be desirable for the CAK to implement a scheme wherein the integral CAM 206A takes over all or a subset of removable CAM 206B functions when the removable CAM 206B is removed, or determined to be defective or compromised.

### CAM Initialization

Each time that either of the CAMs 206 are initialized, the CAK 420 sets the baud rate for communications between the CAK 420 and that CAM 206. The CAK 420 then resets the CAM 206 and retrieves an Answer to Reset (ATR). The ATR is interpreted and the baud rate is set to the desired value. STB 110 information may then be transmitted to the CAM 206, and CAM 206 information (if any) is then sent to the STB 110. to start the decryption process necessary to view the content.

### CAM Operational Allocation/Selection

As described above, the CAK 420 allocates functionality between the integral “chip on board” CAM 206A and the removable CAM 206B. This allocation is remotely controllable (typically, by the headend 434, but also by an independent access control provider) according to data in the control structure 329. This data may be described by the state of one or more flags, numerical, or alphanumerical format. In cases where the operational allocation is simply indicating which CAM 206 will be active and which will not, the data may simply be a single flag.

In one embodiment, upon power-up of the STB 110, the CAK 420 always initializes the integral CAM 206A, and thereafter, reads the control structure 329 to determine the operational allocation between CAMs 206. If the control structure 329 indicates that only the removable CAM 206B should be used for further communication and operations, CAM 206 initialization is restarted on the removable CAM 206B.

### CAM Communication Management and Error Handling

Communications with the CAMs 206 are explicitly managed by the CAK 420. When a CAM 206 is compromised, the STB 110 may be explicitly directed to either communicate only with a specific CAM 206 (white-listing) or told to ignore a specific or group of CAMs 206 (black-listing).

The EMM 262 payload can be used to explicitly carry the identity of a CAM 206 that is authorized to communicate with the STB 110 and CAK 420. Any other CAM 206 is ignored by the STB 110 and CAK 420. The CAK 420 may store any number of authorized CAMs 206 in the whitelist table.

The EMM 262 payload can also be used to explicitly carry the identity of an CAM 206 that is not authorized to communicate with the STB 110 and CAK 420 Any other CAM 207 is accepted by the STB 110 and CAK 420. The CAK 420 may store any number of unauthorized CAMs 206 in the blacklist table.

If errors are detected in communications between the CAK 420 and any of the CAMs 206 (such as acknowledgement errors, parity errors or time out errors), the CAK 420 resets the affected CAM 206, re-initializes the CAM 206 (transmitting STB 110 information to the CAM 206 and retrieving CAM information from the CAM 206) and re-attempts communication with that CAM 206. In one embodiment, if there are additional failures without successful communications, the CAK 420 assumes that there is a CAM failure, cease further communications with that CAM 206 and display an on screen display message indicating the failure.

If a single command is not completed in a suitable amount of time, software running in the STB 110 return an error, and the CAK 420 responds by resetting and reinitializing the CAM 206 and re-attempting communications. Commands may be in any suitable language, including those compliant with the International Standards Organization (ISO).

If a NAK or parity error is detected during an CAM 206 communications transaction, the transaction is terminated and an error returned to the CAK 420. The STB 110 may, but need not attempt retries if such an error is detected. The CAK 420 also enforces a minimum time between the last byte transmitted on one command and the first byte transmitted on the next command. The CAK 420 likewise enforces a minimum time between receipt of the last byte of the ATR and the first byte transmitted on the next command.

### ATR Timeout

During the receipt of the ATR, the ISO specification allows for up to 9600 Elementary Time Units (ETUs) between characters. During the receipt of the ATR, each ETU is defined to be 372 ticks of the clock input to the CAM 206. Accordingly, the STB 110 software times out on the receipt of the ATR if more than 3,571,200 ticks of the clock pass between characters.

### CAM Data Transfer

As described above, it is sometimes desirable for a deployed and installed removable CAM 206B to be replaced with a different removable CAM 206B. This can happen, for example, if the first removable CAM 206B is defective, outdated or compromised, or if it is desirable to introduce a next-generation removable CAM 206 with additional functionality. To facilitate the changeover from the old CAM 206 to a new CAM 206, the CAK 420 supports the transfer of a block of data (a “Transfer Data Block” or TDB) from the old CAM 206 to the new CAM. A CAM data transfer can occur between any combination of the integral CAM 206A and the removable CAM 206B. The CAM data transfer does not require any special user interface implemented in the STB 110.

When a data transfer is to take place, the CAM 206 sets one or more status bytes (SW1/SW2). This can occur because the broadcaster or conditional access provider has decided that a data transfer should take place and has included information specifying as such in the EMM 262, or because the state or internal information of the CAM 206 has changed (for example, due to an IPPV purchase). The CAK 420 monitors these status bytes, and depending on their state, the CAK 420 receives the CAM TDB from the CAM 206.

In one embodiment, the CAM TDB is not parsed or interpreted by the CAK 420. It is private data intended to be transferred from one CAM 206 to another (typically, from one removable CAM 206B to another removable CAM 206B. The CAM TDB is retrieved from the old CAM 206B using multiple commands. The acquisition of the CAM TDB from the old CAM 206B is handled as a low priority CAM 206 communication. In other words, the CAM 206B continues to process ECMs 264 and EMMs 262 as received—even if that occurs during the transmission of a CAM TDB.

When a new CAM 206B is inserted into the STB 110, the CAK 420 transmits the received transfer data to the new removable CAM 206B immediately following the CAM 206B initialization (acquiring the ATR and receiving the CAM information programmed during the CAM fabrication process) and prior to any other communications with the new removable CAM 206B. Thus, information from the previous removable CAM 206B can be transferred to the new removable CAM 206B via the CAK 420.

This feature can also be used to transfer data from the removable CAM 206B to a new CAK 420 (presumably, in a new STB 110). This may be useful in the deployment of later generation STBs 110, because information from the preceding generation STB 110 can be stored in the removable CAM 206B, and thereafter transmitted to the CAK 420 in the new STB 110 by inserting the removable CAM 206B into it.

The transmission and reception of the transfer data is interruptable by ECM 264 or EMM 262 transactions (with the interruption occurring between complete command transactions). Since EMMs 262 can be processed while acquiring the transfer data, it is possible that one of the status bytes can be set or reset. If this occurs, the CAK 420 restarts the acquisition of the transfer data.

The CAK 420 maintains the status of the CAM TDB operations. For each CAMID contained in the CAK control structure 329, the CAK 420 maintains a flag indicating if this CAMID is the currently active CAMID. The CAK 420 also tracks whether or not this CAMID is the “old CAMID” or “new CAMID” and stores a flag indicating whether or not the CAM TDB operation has been successfully completed. When the flag is not set, the CAK 420 will operate with the old removable CAM 206B—and wait for the insertion of the new removable CAM 206B. When the flag is set, the CAK 420 will no longer operate with the old CAMID of the old removable CAM 206B. If the old removable CAM 206B is inserted into the STB, the receives the CAMID of the old removable CAM 206B and takes appropriate action. Such appropriate action may include the display of an on screen message indicating that the wrong SMC has been inserted, or providing reduced services.

CAM TDB operations may be canceled if there is a problem with the CAM TDB transfer and/or if the customer has complained to the broadcaster. In this situation, the broadcaster will transmit a new CAK 420 control structure 329 to the CAK having only the old CAMID enabled. In this case, the CAK 420 will cease operating with the removable CAM 206B associated with the new CAMID and operate only with the old removable CAM 206B associated with the old CAMID. At this time, it is up to the broadcaster to transmit an EMM 262 that will re-activate the old CAMID.

Errors during the CAM TDB process can include (1) incomplete acquisition of CAM TDB, (2) inserting the wrong new removable CAM 206B, and (3) inserting a non-functioning removable CAM 206B.

With regard to the incomplete acquisition of CAM TDB, it is possible to remove the old removable CAM 206B from the STB 110 in the middle of the acquisition of the CAM STB. If this occurs, the CAK 420 can disable further processing and display a message indicating that the old removable CAM 206B should be re-inserted into the STB 110 for period of five seconds. When the old removable CAM 206B is reinserted, the CAK re-acquires the entire CAM TDB, and during this period, normal operations (processing of ECMs 262 and EMMs 264) are suspended. When the acquisition is complete, the CAK 420 displays an on-screen indicating that it is OK to remove the old removable CAM 206B. The CAM TDB transfer operation then proceeds normally.

With regard to the insertion of the incorrect new removable CAM 206B, if an CAM TDB transfer operation is currently “enabled” (the CAK 420 has received a control structure 329 indicating that there are two legal CAMIDs), then the CAK 420 does not respond to any CAM 206, internal or removable, that does not have one of the two legal CAMIDs. If a removable CAM 206B with some other CAMID is inserted into the STB 110, the CAK 420 displays a message indicating that the wrong removable CAM 206B has been inserted.

With regard to the insertion of a non-functioning removable CAM 206B: Any time that a non-functioning CAM 206B is inserted into the STB 110 (the SMK could not get a proper ATR from the CAM 206B), the CAK 420 displays an message indicating that the inserted CAM 206B is not functioning correctly.

### CAM Authorization

The control structure 329 provided in an EMM 262 to the CAK 420 provides information regarding which CAMs 206 are permitted to communicate with the STB 110. To support this functionality, each CAM 206 is associated with a unique identifier CAMID that is stored in the CAM 206 itself The CAMID may be globally unique (no other CAM 206 has the same identifier) or groupwise unique (a group of CAMs 206 and only that group of CAMs 206 share the same identifier). Multiple CAMIDs can be used to specify both groupwise and global uniqueness. Groupwise uniqueness can be used to identify different generations of CAMs 206, for example.

Up to two CAMIDs are allowed to operate with a particular STB 110 at a time. (1) the CAMID of the integral CAM 206A and (2) the CAMID for up to two removable CAMs 206B. If a CAM 206 having any other CAMID is inserted into the STB 110, the CAK 420 causes an on screen display indicating that an illegal CAM 206B has been inserted into the STB 110, and that CAM 206B is ignored.

Prior to the receipt of the first control structure 329 sent in the EMM 262 (which is prior to the first authorization from any broadcaster or headend 424) the CAK 420 allows a CAM 206 with any CAMID. In this mode, any services that are not scrambled or encrypted (in the clear and without associated ECMs 264) can be received and presented. In addition, any scrambled or encrypted services for which the CAM 206 itself provides decryption keys can also be received and presented. In one embodiment, only one CAMID is provided in the control structure 329, and hence, and prior to the first data transfer from the CAM 206 to the CAK 420 (described above), only one CAM 206 is authorized to operate with the CAK 420 and the STB 110. That CAM 206 is the integral CAM 206A.

As described above, the CAK 420 may receive transfer data from the CAM 206 after the processing of each EMM 262 is completed and/or after there are changes made to the IPPV information stored in the CAM 206, as indicated by status bytes SW1/SW2. If a data transfer is imminent (an EMM 262 is to be processed or a change has been made to the IPPV information stored in the CAM 206), the headend provides two CAMIDs in the control structure 329: (1) the CAMID of the integral CAM 206A, and (2) the CAMID of a removable CAM 206B. If the CAMID of the integral CAM 206A has already been provided, the control structure 329 may simply provide the CAMID for the removable CAM 206B.

Since there are now two CAMs 206, which operations are performed by which CAM 206A 206B is determined by the control structure 329 received in the EMM 262. In one embodiment, reception of the control structure 329 is allocated to the integral CAM 206A, and all other functions are allocated to the removable CAM 206B.

After the data transfer from the CAM 206 to the CAK 420 has been completed, there are two valid CAMIDs, the CAMID of the integral CAM 206A and the CAMID of the removable CAM 206B.

If the subscriber attempts to insert a different removable CAM 206B into the STB 110, that new CAM 206B will not operate properly, because its CAMID will not be one of the two approved CAMIDs. The insertion of a new removable CAM 206B, however, can be remotely enabled by transmitting a new control structure 329 having the CAMID of the new removable CAM 206B before the data transfer takes place. The CAMID of the new removable CAM 206B can replace the CAMID of the previously authorized CAM 206B, or can be added to the list of permitted CAMIDs. Or, the control structure 329 may simply transmit a new set of CAMIDs, including the CAMID for the integral CAM 206A, the currently installed removable CAM 206B and the new (and not yet installed) removable CAM 206B.

Some time after the insertion of the new removable CAM 206B in the STB 110, a second data transfer will take place (triggered by either the receipt of an EMM 262 or a change in IPPV data). When that data transfer takes place, the CAMID of the newly inserted removable CAM 206B is provided to the CAK 420. The CAK 420 compares the received CAMID with the CAMID(s) received in the control structure 329, and if they match, the new removable CAM 206B is now operable with the STB 110. The CAMID of the previously inserted CAM 206B can be retained, but typically, would be discarded.

### Semaphore Protection

The CAK 420 manages at least two tasks that communicate with the CAM 206. IN addition, there may also be several CAK application program interface (API) calls that require communication with the CAM 206. Such communications occur in the context of the task of the calling algorithm, typically, one of the STB applications 418. To ensure that only one CAM 206 transaction occurs at a time, the CAK 420 protects all CAM 206 communications with a semaphore. The semaphore is set prior to starting a transaction with the CAM 206 and is cleared after the transaction is complete.

### Conditional Access Table (CAT) Processing

The CAT is a table defined by the MPEG-2 Systems specification (ISO 13818-1) that is transmitted on PID 1 of all transport streams. It contains data that is private to the conditional access provider. The CAT also contains the conditional access system identification number for the conditional access system supplier and the package identifier (PID) locations of the EMM 262 stream or streams associated with the conditional access system provider.

More than one EMM 262 stream can be associated with a single conditional access system provider. For example, if the conditional access system uses more than one generation of CAM 206, the conditional access system provider could decide to use separate EMM 262 streams for each CAM 206 generation. The PID for each EMM 262 can be specified in the CAT.

The CAT, which includes an identifier for the conditional access system provider, is provided to the CAK 420, and the CAK 420 provides the conditional system identifier to the appropriate STB application 418. Thereafter, the STB application 418 ensures that any CAT provided to the CAK 420 has the proper system identifier.

A CAT is acquired by the STB application 418 and delivered to the CAK 420 (1) on power-up—the CAT associated with the current transport stream is delivered to the CAK 420 on power-up; (2) upon version number change—anytime the version number in the CAT changes, the new CAT is delivered to the CAK 420; and (3) when there is a new transport stream—anytime the viewer changes channel and that channel change moves the STB 110 to a new transport stream (typically, setting the STB 110 to receive a data stream transmitted on a new frequency), the CAT on that transport stream must be delivered to the CAK 420.

Each time a CAT is delivered to the CAK 420, the CAK 420 (1) checks to see if the CAT has the identifier of the conditional access system provider—the CAK 420 returns an error if the CAT does not have the proper identifier; (2) parses the CAT to find the EMM 262 PID that is appropriate for the generation of the CAM 206 being used in the STB 110; and (3) gives that PID number to the STB 110 for further processing.

### EMM Processing

The CAK 420 is responsible for processing EMMs 262. Each EMM 262 contains a series of descriptors. Some of the descriptors are messages for the CAK 420, while others are blocks of data that are to be processed by one or both of the CAMs 206.

The broadcast of EMMs 262 is not necessarily matched to the rate at which EMMs 262 can be processed in the STB 110. In fact, the typical authorization will probably require that multiple EMMs 262 be sent to a STB 110 over a short amount of time. To handle the problem of mismatch between broadcast rate and processing rate, the CAK 420 buffer EMMs 262 prior to processing.

Each time an EMM 262 is received from the associated STB application 418, the CAK 420 checks to see if there is room in the EMM 262 buffer. If there is sufficient space, the EMM 262 is added to the buffer and the EMM 262 processing task is notified. If there is not sufficient space in the buffer, the EMM 262 will be discarded without any processing.

### Pairing Key Transmission

CAMs 206 and STBs 110 can be paired. This pairing configures the CAM 206/STB 110 such that a particular STB 110 will only operate with an approved CAM 110. Such pairing can be groupwise (e.g. a group of STBs 110 only operate with CAMs of a particular group, or an STB 110 operates with a group of CAMs 306). Or, the pairing may be individual. That is, an particular STB 110 will operate with paired CAM(s) 206, but not with a CAM 206 from any other subscriber.

To pair an STB 110 to a CAM 206, one or more pairing keys Pₖ, are generated. Each pairing key is unique for each deployed STB 110 are generated. The pairing key(s) Pₖ are provided to the STB 110 and CAM(s) 206 and used to encrypt communications between the STB 110 and the CAM(s) 206, thereby cryptographically binding the CAM(s) 206 to the STB 110, and assuring that an unapproved CAM 206 cannot be used with the STB 110.

The pairing key(s) Pₖ can be incorporated into the STBs 110 and CAM(s) 206 when they are manufactured, or they can be delivered and stored after they are sold and deployed. In embodiments where the pairing key(s) Pₖ are delivered and stored after deployment, secure delivery is assured by using shared secret or public/private encryption techniques. Using the shared secret technique, the pairing key(s) Pₖ are encrypted with either with one or more secrets shared with the STB 110 and CAM(s) 206, and decrypted with the shared secret to extract the pairing key. Using the public/private key technique, the pairing keys are encrypted with the private key of the STB 110 and the private key of the CAM(s) 206, and after receipt, decrypted by the STB 110 and the CAM(s) 206 using their public key.

Thereafter, communications between the STB 110 and CAM(s) 206 are encrypted according to the pairing key(s). Since pairing keys are unique, message transmitted between the STB 110 and CAM 206 can only be deciphered by the paired device.

In one embodiment, the generation and encryption of the pairing key(s) Pₖ is accomplished by a pairing server, which is an entity separate from the headend or broadcaster. In this embodiment, the headend or broadcaster acts as a go-between to deliver the appropriate information, but has no knowledge of the pairing key or the key(s) used to encrypt the pairing key before sending it to the STB 110 and CAM 206. Typically, STB 110/CAM 206 pairing is accomplished separately (using different pairing keys Pₖ for each broadcaster.

### ECM Processing

The CAK 420 is responsible for processing ECMs 264. Each ECM 264 contains a series of descriptors. Some of the descriptors are messages to the CAK 420. Others are blocks of data that must be processed by one or both of the CAMs 206.

One of the functions of the CAK 420 is to deliver decryption keys to the appropriate modules for so that authorized media programs and services can be decrypted and presented to the subscriber. This is accomplished by processing descriptors in the ECM 264. Depending on the allocation of functions between the CAMs 206, the descriptors can be processed in either or both of the CAMs 206. In one embodiment, the releasably coupleable CAM 206B performs all functions other than processing of the control structure 329, and hence the descriptors are processed in the releasably coupleable CAM 206B.

One descriptor instructs the CAK 420 to retrieve authorization information (which includes the decryption key required to decrypt the selected program) from the CAM 206. The CAK 420 retrieves this information, and determines whether the service is authorized. If so, the CAK 420 provides the decryption keys to the appropriate STB application 418.

In one embodiment, the decryption key is encrypted before it is provided to the CAK 420 and the STB 110 using the pairing key Pₖ described above.

The STB 110 is responsible for delivering one ECM 264 of each parity to the CAK 420 as it is received in the STB 110. The CAK 420 will process each ECM 264 as received and provide decryption keys if the service is authorized. Once an ECM 264 has been delivered, the STB 110 should not deliver another ECM 264 until the parity in the ECM 264 has changed.

The STB 110 may include multiple tuners, which permit the reception of multiple signals from the same or different satellite transponders at the same time. Typically, the CAK 420 needs to process only one ECM 264 per key period per tuner. However, if the CAM 206 detects a problem with its portion of an ECM 264 (typically a problem with the digital signature associated with the ECM 264), it can request that the CAK 420 obtain another copy of the current ECM 264. The CAK 420 requests that the STB 110 deliver next ECM 264 of any parity. This new ECM 264 will be processed by the CAK 420 when received.

If the CAM 206 makes this request three times in a row, the CAK 420 generates a message (e.g. an on-screen display message) indicating that the security level in the broadcast does not match the security level of the CAM 206. Presentation of the services related to the problem ECMs 264 are disabled, although processing of other ECMs 264 continues. At any time, if an ECM 264 is successfully processed, the message may be removed. If a valid ECM 264 is received, it is processed and the corresponding video is decrypted. This is true even if several consecutive invalid ECM's 264 are received prior to the receipt of the valid one.

In order to handle changes in CAM 206 authorization, the CAK 420 stores the most recent ECM 264 for each tuner being supported. If an EMM 262 includes a descriptor that indicates a change in CAM 206 authorization, then the CAK 420 re-sends all stored ECMs 264 (one for each tuner) to the CAK 420 for processing.

In one embodiment, there is only one ECM 264 stream per channel. The authorization and decryption key generated from that ECM 264 applies to all services associated with that channel (video service, one or more audio services, and optionally one or more data services).

### IPPV Operations Support

The following operations are performed to support subscriber-selected pay per view services. First, an ECM 264 associated with the PPV media program is received by the CAK 420 and transmitted to the CAM 206. If the CAM 206 determines that the media program is one can be purchased (e.g. the subscriber is authorized, there are sufficient funds in the electronic wallet, the media program is in the temporal purchase window, and the media program has not already been purchased), the CAM 206 transmits purchase information to the CAK 420. This purchase information can include an event identifier that identifies the media program (which may include a broadcaster identification number), the purchase price (typically in local units of currency), and some status bits. The CAK 420 forwards this purchase information to the appropriate STB application 418 for further processing.

The STB 110 includes software modules that include a user interface that offers the IPPV purchase to the viewer. Preferably, this user interface presents information necessary to make the purchase to the viewer. This information may include, for example, the cost of the IPPV media program and the remaining balance of the electronic wallet. Should the viewer elect to make an IPPV purchase of the media program, the STB 110 accepts the appropriate selection via a user interface.

The STB 110 provides the information to the CAK 420, which forwards the information to the CAM 206. The CAM 206 logs the purchase, and deducts the price from the balance in the electronic wallet. This deduction can take place immediately or when the first ECM 264 is processed, as discussed below.

The CAK/CAM must validate that the subscriber has the appropriate spending level to proceed with the purchase/viewing process. This can be accomplished by comparing the subscriber's account balance stored in the CAM(s) 206 with the cost of the requested purchase. The CAK 420 then re-sends the most recent ECM 264 for the tuner that will receive the IPPV purchase to the CAM 206. The service is now authorized with the appropriate authorization information and decryption key.

The CAK 420 provides a means to retrieve the current available balance for PPV purchases for each broadcaster, while the CAM 206 provides an indication of the number of broadcasters being supported. The CAK 420 is also able to query the CAM 206 regarding the available balance for each of these broadcasters.

### Virtual Groups

When an removable CAM 206B is inserted in the STB 110 or the STB 110 is powered up in the case of an embedded or integral CAM 206A on the motherboard, a group number of the CAM 206 (along with the CAMID) is passed the CAK 430 and is used to identify which group EMMs 262 should be passed to the CAM 206. Groups are typically assigned when the CAM 206 is manufactured, and membership in these groups become sparse once cards have been in the field. This is due to the fact that some CAMs 206 become unsubscribed or are never activated.

To ameliorate this problem, CAMs 206 can be supplied with one ore more virtual groups identifiers. These identifiers can be stored at the time of manufacture, or can be transmitted from the headend to the CAM 206 via the CAK 420, and hence, can be changed after the CAMs 206 are deployed and in use. When the removable CAM 206B is inserted or the integral CAM 206A is powered up, these virtual groups can be passed from the CAMs 206 to the CAK 420 so that the CAK has the information necessary to route appropriate EMMs 262 in the virtual groups to the CAM(s) 206. By virtue of the exchange of this information, virtual groups can be created and distributed to CAMs 206 that are already deployed and in the field. Such virtual groups can be used to efficiently distribute group EMMs 262, thus saving bandwidth within the broadcast infrastructure.

Those skilled in the art will recognize many modifications may be made to this configuration without departing from the scope of the present invention. For example, those skilled in the art will recognize that any combination of the above components, or any number of different components, peripherals, and other devices, may be used with the present invention.

### Conclusion

This concludes the description of the preferred embodiments of the present invention. The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. An apparatus for providing conditional access to media programs, comprising:
a receiver, having a first conditional access module, integral with the receiver;
a second conditional access module, removably communicatively coupleable with the receiver;
wherein the receiver further comprises a conditional access kernel, for controlling conditional access operations of the first conditional access module and the second conditional access module according to a control structure received by the receiver from a remote source.

2. The apparatus of claim 1, wherein the conditional access kernel allocates a plurality of conditional access operations between the first conditional access module and the second conditional access module according to the control structure.

3. The apparatus of claim 2, wherein:
the media programs include encrypted media programs encrypted according to a control word (CW) and unencrypted media programs,
the conditional access operations allocated between the first conditional access module and the second conditional access module include:
processing entitlement control messages to generate the control word; and
processing entitlement management messages to generate the control structure.

4. The apparatus of claim 2, wherein the conditional access functional allocation comprises selecting one of the first conditional access module and the second conditional access module to be operational and a non-selected conditional access module to be non-operational.

5. The apparatus of claim 2, wherein the conditional access functional allocation comprises allocating initialization operations to the first conditional access module and post initialization operations to the second conditional access module.

6. The apparatus of claim 5, wherein the initialization operations include the processing of non-encrypted messages and excludes the processing of encrypted messages.

7. The apparatus of claim 1, wherein the conditional access functional allocation is dependent upon the operational status of the first conditional access module and the second conditional access module.

8. The apparatus of claim 1, wherein the remote source is the broadcaster.

9. The apparatus of claim 1, wherein the conditional access kernel enables operation of only the first conditional access module if a control structure has not been received.

10. The apparatus of claim 1, wherein:
the first conditional access module and the second conditional access module are members a group of conditional access modules, each member of the group of conditional access modules being identified by an associated conditional access module identifier (CAMID); and
the control structure received from the remote source specifies the CAMIDs of conditional access modules which are permitted to operate with the receiver.

11. The apparatus of claim 1, wherein:
the first conditional access module and the second conditional access module are members a group of conditional access modules, each member of the group of conditional access modules being identified by an associated conditional access module identifier (CAMID); and
the control structure received from the remote source specifies the CAMIDs of conditional access modules which are not permitted to operate with the receiver.

12. The apparatus of claim 1, wherein the conditional access operations include the communication of operational data between the first conditional access module and the second conditional access module.

13. The apparatus of claim 12, wherein the operational data is transmitted from the second conditional access module to the first conditional access module, and subsequently transmitted from the first conditional access module to a third conditional access module inserted into the receiver to replace the second conditional access module.

14. The apparatus of claim 12, wherein the operational data is transmitted from the second conditional access module to the first conditional access module after reception of an entitlement management message having the entitlement management information describing permitted services, and subsequently transmitted from the first conditional access module to a third conditional access module inserted into the receiver to replace the second conditional access module.

15. The apparatus of claim 12, wherein the second conditional access module stores pay-per-view data and the operational data is transmitted from the second conditional access module to the first conditional access module upon a change in the pay-per-view data, and subsequently transmitted from the first conditional access module to a third conditional access module inserted into the receiver to replace the second conditional access module.

16. A method for providing conditional access to media programs, comprising the steps of:
receiving a control structure from a remote source in a conditional access kernel of a receiver that receives the media programs;
controlling the operations of the first conditional access module and the second conditional access module according to the control structure; and
wherein the first conditional access module is integral with the receiver and the second conditional access module removably coupleable with the receiver.

17. The method of claim 16, further comprising the step of:
allocating a plurality of conditional access operations between the first conditional access module and the second conditional access module according to the control structure.

18. The method of claim 17, wherein prior to the step of receiving the control structure, the conditional access kernel enables operation of only the first conditional access module.

19. The method of claim 17, wherein the step of controlling the operations comprises the step of enabling operations of only one of the first conditional access module and the second conditional access module.

20. The method of claim 17, wherein the operations comprise a first group of operations and a second group of operations, and the conditional access kernel enables the first conditional access module to perform the first group of operations and enables the second conditional access module to perform the second group of operations

21. The method of claim 17, wherein the operations comprise conditional access operations for the processing of entitlement management information to generate entitlement control information.

22. The method of claim 17, wherein the conditional access kernel enables operation of only the first conditional access module if a control structure has not been received.

23. The method of claim 17, wherein:
each conditional access module is identified by an associated conditional access module identifier (ID); and
the control structure received from the remote source specifies the IDs of conditional access modules which are permitted to operate.

24. The method of claim 17, wherein:
each conditional access module is identified by an associated conditional access module identifier (ID); and
the control structure received from the remote source specifies the IDs of conditional access modules which are not permitted to operate.

25. The method of claim 17, wherein the operations of the first conditional access module and the second conditional access module include the communication of operational data between the first conditional access module and the second conditional access module.

26. The method of claim 17, wherein the operational data is transmitted from the second conditional access module to the first conditional access module, and subsequently transmitted from the first conditional access module to a third conditional access module inserted into the receiver to replace the second conditional access module.

27. The method of claim 17, wherein the operational data is transmitted from the second conditional access module to the first conditional access module after reception of each entitlement management message having the entitlement management information, and subsequently transmitted from the first conditional access module to a third conditional access module inserted into the receiver to replace the second conditional access module.

28. The method of claim 17, wherein the second conditional access module stores pay-per-view data and the operational data is transmitted from the second conditional access module to the first conditional access module upon a change in the pay-per-view data, and subsequently transmitted from the first conditional access module to a third conditional access module inserted into the receiver to replace the second conditional access module.
